(19) United States
(12) Patent Application Publication
(10) Pub. No.: US 2024/0232782 A1
(43) Pub. Date: Jul. 11, 2024

(54) SECURE COMPUTING SYSTEM, BUSINESS OPERATOR SERVER, INFORMATION PROCESSING SYSTEM, SECURE COMPUTING METHOD, AND RECORDING MEDIUM

(71) Applicant: NEC CORPORATION, Minato-ku ,Tokyo (JP)

(72) Inventors: Yoji MORI, Tokyo (JP); Toshio Koide, Tokyo (JP); Wataru Itonaga, Tokyo (JP)

(73) Assignee: NEC Corporation, Minato-ku, Tokyo (JP)

(21) Appl. No.: 18/572,248

(22) PCT Filed: Jun. 25, 2021
(86) PCT No.: PCT/JP2021/024164

§ 371 Date: Dec. 20, 2023

(51) Int. Cl. G06Q 10/067; G06F 21/62

(52) U.S. Cl. CPC G06Q 10/067; G06F 21/6245

(57) ABSTRACT

This secure computing system comprises: a parameter acceptance means for accepting, with regard to a plurality of models used for analysis of the optimization of a city based on the personal data of individuals belonging to the city and having been generated by each of a plurality of business operators, input of a plurality of concealed parameters of the plurality of models; a secure computing means for integrating by secure computation, with regard to the plurality of concealed parameters; and an output means for outputting the parameters in a concealed form that have been integrated by the secure computing means.

### TECHNICAL FIELD

The present disclosure relates to a secure computing system, a business operator server, an information processing system, a secure computing method, and a recording medium.

### BACKGROUND ART

An administrative agency analyzes a solution method of a task of a local government by using personal information of residents and the like held therein. As a means for analyzing a method for solving the task, a model using artificial intelligence (AI) is used. In order to improve the performance and accuracy of the model, a technique of performing prediction processing on data of personal information distributed while protecting privacy is used.

For example, PTL 1 discloses a system that performs prediction processing in an encrypted state using an encrypted prediction model and user information encrypted by a method similar to that of a distributed prediction model.

### CITATION LIST

### Patent Literature

PTL 1: JP 2019-215512 A

### SUMMARY OF INVENTION

### Technical Problem

However, in the invention described in PTL 1 described above, since data predicted by a single prediction model is output, there is a limit to improving the accuracy of prediction data. When a service business operator whose business is commissioned by a local government of a city analyzes personal information of a resident, it is possible to generate a more accurate model by using information of models held by a plurality of service business operators than by using models held by individual service business operators. However, since the model held by each service business operator is information to be used as know-how, there is a case where it is desired to conceal the model in the service business operator.

An object of the present disclosure is to provide a more accurate model while concealing each model.

### Solution to Problem

A secure computing system according to an aspect of the present disclosure includes: a parameter acceptance means for accepting, with regard to a plurality of models used for analysis of an optimization method of a city based on the personal data of individuals belonging to the city and having been generated by each of a plurality of business operators, input of a plurality of concealed parameters of the plurality of models: a secure computing means for integrating by secure computation, with regard to the plurality of concealed parameters: and an output means for outputting the parameters in a concealed form that have been integrated by the secure computing means.

A business operator server according to an aspect of the present disclosure includes: a model storage means that stores a model for analyzing an optimization method of a city based on personal data of an individual belonging to the city: a concealing means that conceals parameters of a model stored in the model storage means: a model input/output means that transmits parameters of the model to a secure computing system in a concealed form: a restoration means that restores the concealed parameter: and an analysis means that performs analysis regarding optimization of the city by using an updated model updated by federated learning using secure computation based on information held by each city. The analysis means outputs a proposed action for solving a task in the city based on personal data of a resident belonging to the city.

An information processing system according to an aspect of the present disclosure is an information processing system including: a plurality of business operator servers: and a secure computing system. The plurality of business operator servers each include: a model storage means that stores a model generated based on personal data of an individual belonging to each city and performs analysis of an optimization method of the city: a concealing means that conceals a parameter of a model stored in the model storage means: a model input/output means that transmits a parameter of a model to a secure computing system in a concealed form: and a restoration means that restores the concealed parameter. The secure computing system includes: a parameter acceptance means that is used for analysis of an optimization method of a city based on personal data of an individual belonging to the city, and accepts, for a plurality of models generated by each of a plurality of business operators, input of a plurality of concealed parameters of the plurality of models: a secure computation means that integrates the plurality of concealed parameters by secure computation: and an output means that outputs the parameters integrated by the secure computing means in a concealed form.

A secure computing method according to an aspect of the present disclosure includes: performing analysis of an optimization method of a city based on personal data of an individual belonging to the city, and accepting input of a plurality of concealed parameters for a plurality of models generated by each of a plurality of business operators: integrating the plurality of concealed parameters by secure computation; and outputting the integrated parameters in a concealed form.

A recording medium according to an aspect of the present disclosure has stored therein a program for causing a computer to execute: analyzing an optimization method of a city based on personal data of an individual belonging to the city, and accepting a plurality of concealed parameters of a plurality of models generated by each of a plurality of business operators: integrating the plurality of concealed parameters by secure computation; and outputting the integrated parameters in a concealed form.

### Advantageous Effects of Invention

An example of an effect of the present disclosure is that a more accurate model can be provided while concealing each model.

### BRIEF DESCRIPTION OF DRAWINGS

FIG. 1 is a block diagram illustrating a configuration of an information processing system according to a first example embodiment.

FIG. 2 is a diagram for explaining a service business operator that implements the information processing system according to the first example embodiment.

FIG. 3 is a diagram illustrating a hardware configuration in which a secure computing system according to the first example embodiment is implemented by a computer device and its peripheral device.

FIG. 4 is a flowchart illustrating an operation of secure computation according to the first example embodiment.

FIG. 5 is a block diagram illustrating a configuration of an information processing system according to a second example embodiment.

FIG. 6 is a flowchart illustrating an operation of information processing according to the second example embodiment.

FIG. 7 is a block diagram illustrating a configuration of a contractor selection unit according to a modification of the second example embodiment.

FIG. 8 is a flowchart illustrating an operation of the contractor selection in a modification of the second example embodiment.

### EXAMPLE EMBODIMENT

Next, example embodiments will be described in detail with reference to the drawings.

### First Example Embodiment

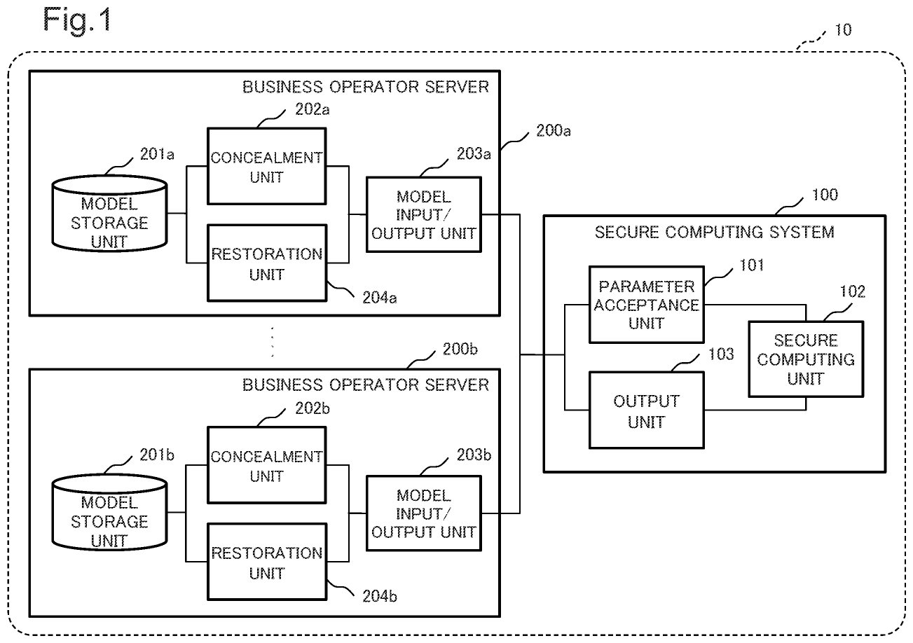

FIG. 1 is a block diagram illustrating a configuration of an information processing system 10 according to a first example embodiment.

Referring to FIG. 1, the information processing system 10 includes a secure computing system 100 and a plurality of business operator servers 200 (200a, 200b). The secure computing system 100 includes a parameter acceptance unit 101, a secure computing unit 102, and an output unit 103. The secure computing system 100 is implemented by a model association business operator who provides analysis tools and the like of a city optimization method to each service business operator. Each of the business operator servers 200 includes a model storage unit 201 (201a, 201b) that stores a learned model for analyzing personal information (personal data) of a resident or information regarding city optimization, a concealment unit 202 (202a, 202b) that conceals parameters, a model input/output unit 203 (203a, 203b) that inputs/outputs parameters to/from the secure computing system 100, and a restoration unit 204 (204a, 204b) that restores the concealed parameters. In the present example embodiment, the plurality of business operator servers 200 are provided at two locations, but the present invention is not limited thereto. The plurality of business operator servers 200 are provided as many as the number of service business operators that perform federated learning. Hereinafter, the secure computing system 100 which is an essential configuration of the present example embodiment will be described in detail.

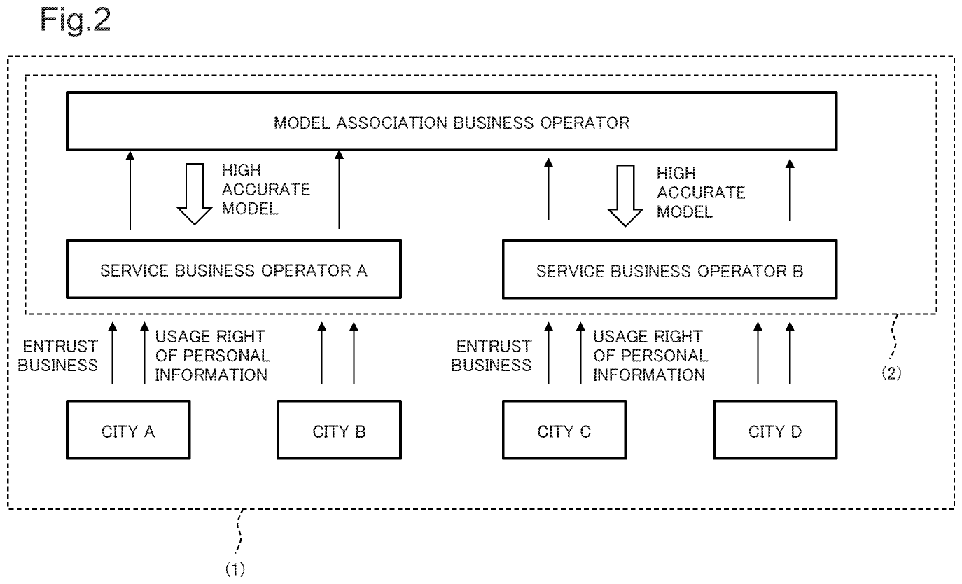

FIG. 2 is a diagram for explaining a service business operator that implements the information processing system 10 according to the first example embodiment. As illustrated in FIG. 2, as an example of an aspect of the first example embodiment, each of service business operators A and B is entrusted with a project related to a task of a city by a city A and a city B, and a local government that supervises a city C and a city D, and is permitted to use personal information of residents belonging to the entrusted city. In this case, in the present example embodiment, each of the service business operators A and B generates a model for analyzing a task of a city by using information of a resident received from each city. Next, the service business operators A and B transmit the model parameters to the model association business operator in a concealed form. Upon receiving the plurality of concealed parameters, the model association business operator integrates the plurality of parameters. As one aspect of the present example embodiment, the model association business operator is used to integrate the models generated by the service business operators and generate a more accurate model ((1) in FIG. 2). In FIG. 2, the direction of the arrow between the service business operator and the model association business operator indicates the direction in which the information on the parameter is transmitted. The model association business operator acquires the concealed parameters of the model from the service business operators A and B, and transmits the integrated parameters to each service business operator in the concealed form.

As an example of another aspect of the first example embodiment, the parameters of the model owned by each of the service business operators A and B are integrated by the model association business operator using secure computation to generate a more accurate model ((2) in FIG. 2).

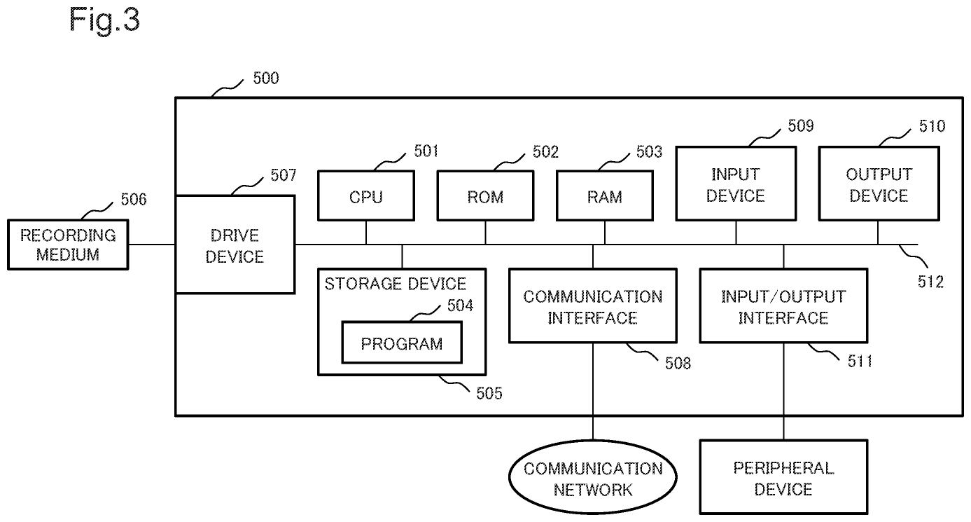

FIG. 3 is a diagram illustrating an example of a hardware configuration in which the secure computing system 100 according to the first example embodiment of the present disclosure is achieved by a computer device 500 including a processor. As illustrated in FIG. 3, the secure computing system 100 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data. In the first example embodiment, the parameter information received from each business operator server 200 is input to the secure computing system 100 via the input/output interface 511.

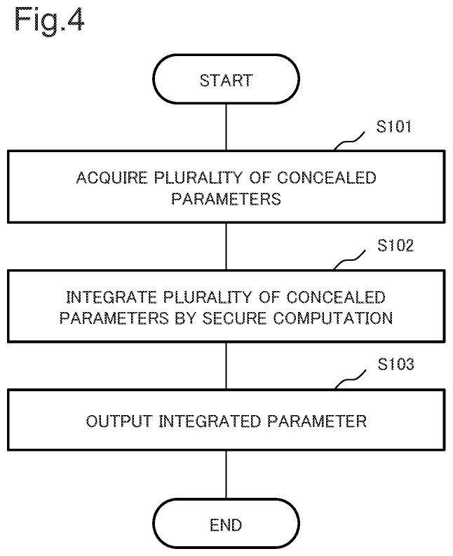

The CPU 501 operates the operating system to control the entire secure computing system 100 according to the first example embodiment of the present invention. The CPU 501 reads a program and data from a recording medium 506 mounted on, for example, a drive device 507 to a memory. The CPU 501 functions as the parameter acceptance unit 101, the secure computing unit 102, the output unit 103, and a part thereof in the first example embodiment, and executes processing or a command in the flowchart illustrated in FIG. 4 to be described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm an output.

As described above, the first example embodiment illustrated in FIG. 1 is implemented by the computer hardware illustrated in FIG. 3. However, the means for implementing each unit included in the secure computing system 100 of FIG. 1 is not limited to the configuration described above. The secure computing system 100 may be implemented by one physically coupled device, or may be implemented by a plurality of devices by connecting two or more physically separated devices in a wired or wireless manner. For example, the input device 509 and the output device 510 may be connected to the computer device 500 via a network. The secure computing system 100 according to the first example embodiment illustrated in FIG. 1 can be configured by cloud computing or the like.

In FIG. 1, the parameter acceptance unit 101 is used for analysis of a city optimization method, and is a means for accepting input of a plurality of concealed parameters of a plurality of models. The plurality of models are generated by each of the plurality of business operators based on, for example, information on individuals belonging to each of the cities. For example, the parameter acceptance unit 101 receives and accepts the parameters of the learned model in each of the plurality of business operator servers 200 through the communication I/F 508 in a concealed form via a network with an operation for integrating the parameters by the model association business operator as a trigger. The learned model is a model determined in advance by machine learning in order to output a specific analysis result using, for example, personal data of a resident or entrusted business information from an administrative agency in each business operator server 200. The model for machine learning includes, but is not limited to, a decision tree model, a linear regression model, a logistic regression model, a neural network model, and the like.

The personal data is personal data of a specific individual, and includes, for example, attribute information, health information, a degree of happiness (degree of well-being), behavior history information, or personal information collected from a sensor. The personal data is obtained by converting a questionnaire, a medical examination result, or sensing data obtained from an individual into attribute information, health information, a degree of well-being, a behavior history, a situation, a state, or the like. The attribute information is, for example, age or sex. The health information is, for example, information indicating a physique such as a height and a weight or information of a result of a health examination. The degree of well-being is, for example, information from which a demand or a degree of happiness in an individual's life can be extracted based on a questionnaire result or the like. The situation is, for example, information that allows grasping of personal recent conditions obtained from the contents of a notification to an administrative agency. The state is information obtained from sensing data or behavior history data. These pieces of information are acquired from, for example, a mobile terminal possessed by an individual or a sensor or a camera provided in a town through a network.

The secure computing unit 102 is a means that integrates a plurality of parameters received and concealed by the parameter acceptance unit 101 by secure computation. In the present example embodiment, the integration of the plurality of concealed parameters by secure computation means that the secure computing system 100 performs machine learning in a state of being distributed to each of the business operator servers 200 (federated learning), and the parameters of the models learned in each of the business operator servers 200 are integrated using secure computation. In the present example embodiment, it is also included that the secure computing system 100 integrates the parameters of the model machine-learned by each of the business operator servers 200.

The secure computing unit 102 integrates the concealed parameters according to a predetermined combination rule. As a parameter integration method, a known method can be used, and for example, at the time of integration, the weight of the parameter relevant to each model can be changed according to the feature of each model.

As the secure computing method, special encryption relevant to specific processing such as homomorphic encryption, a trusted execution environment in which processing is performed in a state of being isolated on hardware, multi-party computation in which computation processing (secure variation computation) is performed in a state of being securely distributed by a plurality of servers, or the like can be used. A specific method of the secure computation of the multi-party computation includes the following examples. For example, the concealed data a is distributed securely to the distributed values x, y, . . . , and the administrator transmits x, y, . . . to different servers. Next, the computation is advanced while performing communication with each other in a state where the concealed data a is distributed securely, and finally the distributed values u, v, . . . of the outputs, which are the computation results of the servers, are collected and restoration processing is performed, whereby F(a) of the computation result is obtained. This computation result is a parameter obtained by integrating parameters of each model. Therefore, in a case where the multi-party computation is used as the secure computing method, the secure computing unit 102 includes a plurality of servers. According to the multi-party computation, management of an encryption key and an isolated environment are unnecessary, and computation processing is faster. The secure computing unit 102 outputs the parameters of the model thus obtained to the output unit 103 in a concealed form.

The output unit 103 is a unit that transmits the parameters integrated by the secure computing unit 102 to the business operator server 200. The output unit 103 transmits the integrated parameters in a format that allows the model parameters to be updated on the business operator server 200 side. When transmitting to the business operator server 200, the output unit 103 can transmit not the updated parameter but a difference (only an improvement point) of the updated parameter.

The operation of the secure computing system 100 configured as described above will be described with reference to the flowchart of FIG. 4.

FIG. 4 is a flowchart illustrating an outline of the operation of the secure computing system 100 according to the second example embodiment. The processing according to this flowchart may be executed based on program control by the processor described above.

As illustrated in FIG. 4, first, the parameter acceptance unit 101 receives inputs of a plurality of concealed parameters for each of the models learned in the plurality of business operator servers 200 (step S101). Next, the secure computing unit 102 integrates the plurality of concealed parameters by secure computation (step S102). Finally, the output unit 103 outputs the model parameters calculated by the secure computing unit 102 in a concealed form (step S103). As described above, the secure computing system 100 terminates the operation of secure computation.

In the secure computing system 100, the secure computing unit 102 integrates a plurality of concealed parameters by secure computation. As a result, it is possible to provide a more accurate model while concealing the parameters of each model.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. An information processing system 11 in the second example embodiment is used to provide a model updated by federated learning using secure computation. These updated models are used, for example, as a tool for analyzing a city optimization method for achieving a smart city. Similarly to the computer device illustrated in FIG. 3, each component in each example embodiment of the present disclosure can be achieved not only by hardware but also by a computer device or firmware based on program control. These models are, for example, models generated based on a task (request) of an individual or task information of a city, and an action or plan for solving the task, and are stored in each model storage unit 211 (211a, 211b) of each business operator server 210 (210a, 210b).

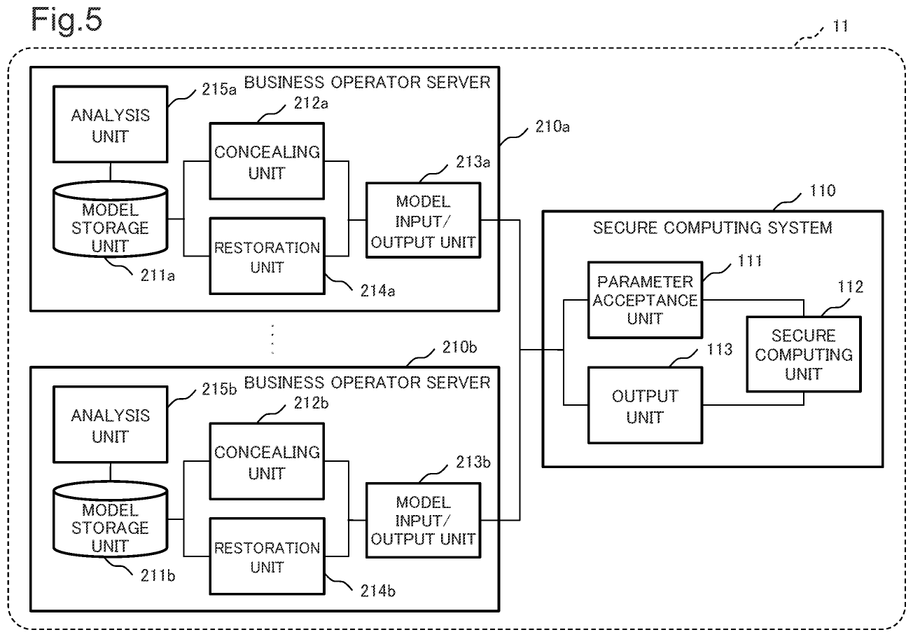

FIG. 5 is a block diagram illustrating a configuration of the information processing system 11 including a secure computing system 110 according to the second example embodiment of the present disclosure. With reference to FIG. 5, the secure computing system 110 and the business operator server 210 (210a, 210b) according to the second example embodiment will be described focusing on portions different from the information processing system 10 according to the first example embodiment. The secure computing system 110 according to the second example embodiment includes a parameter acceptance unit 111, a secure computing unit 112, and an output unit 113. The plurality of business operator servers 210 (210a, 210b) includes a model storage unit 211 (211a, 211b), a concealing unit 212 (212a, 212b), a model input/output unit 213 (213a, 213b), a restoration unit 214 (214a, 214b), and an analysis unit 215 (215a, 215b). The secure computing system 110 integrates a plurality of parameters of the learned model received from the plurality of business operator servers 210a and 210b by using secure computation.

Here, details of each model used for analysis of the city optimization method will be described based on information on individuals belonging to each city. The city optimization in the present example embodiment is, for example, solving a city task. The city optimization method is a method for solving a city task.

The city in the present example embodiment refers to, for example, an area controlled by a specific administrative agency or the administrative agency, and includes not only an area where population is concentrated but also a local area. The task of the city is indicated as, for example, an achievement index or an optimization target which is an index value for quantitatively grasping an achievement (degree of achievement) of a business relevant to an administrative agency's task set by each city. Examples of the administrative agency's tasks include health promotion of residents, economic promotion of cities, environmental tasks, and the like. For example, if the administrative agency's task is health promotion of residents, an achievement index such as a 10% reduction in long-term care insurance premiums and a 20% reduction in medical expenses is set.

The optimization target is a specific measure for achieving an achievement index, and is information that enables analysis of a proposed action for executing the measure when input to a learned model. The proposed action is an action recommended to each individual in order to solve the city task. The proposed action is, for example, an action that solves a task in a city and satisfies a request of an individual. The request of the individual is, for example, a request analyzed based on personal data acquired from the individual.

For example, when the optimization target is health promotion of the resident, the proposed action includes contents such as causing the resident to walk a specific distance or improving the numerical value of a specific item of the medical examination result. These models can be updated to parameters reflecting analysis results in each city by integrating a plurality of parameters of models learned in each service business operator, so that the accuracy of the model can be improved. Here, a model used in the present example embodiment will be described.

An example of the model used in the present example embodiment is a model generated by learning personal data of an individual and a classification name classified based on the personal data as learning data. Examples of the method of classifying an individual include classification according to an attribute (age, sex), classification according to an ingestible food according to a medical examination result, and classification according to a required amount of exercise according to an exercise history such as a walking amount.

Another example of the model used in the present example embodiment is a model that specifies and outputs a proposed action for an individual by inputting classification information to a learned model. In this model, for example, in the learning process, a learned model indicating a relationship between one or more combinations of the classification and the optimization target acquired as the learning data and the action indicating the correct answer label of the learning data (to achieve the request and the optimization target) is generated for each combination using a neural network, graph AI, or another machine learning algorithm. At the time of learning, the model may be updated and enhanced by verifying the learned model based on a proposal approval rate from the individual when the proposed action is actually presented to the individual.

In the estimation process, when classification information is input, the content of the proposed action that satisfies the request and the optimization target is estimated using the learned model relevant to the combination of the classification and the optimization target. As described above, the model is learned using the learning data, and the content of the proposed action is specified. The model is a model in which, for example, in a case where an individual's request is a healthy life, when an ingestible food (for example, the amount of salt per day, and the like) is input as classification information, a recommendation list of a menu is output. Another example of the model is a model in which, when an amount of exercise required for the model, position information of an individual, or position information of a restaurant is input, a recommendation list of each restaurant is output. As another example of the model, when a menu in a restaurant is input, a menu recommended from the menu is output. In this model, even in one restaurant, menus in a plurality of restaurants may be input.

### <Secure Computing System>

The secure computing unit 112 receives the parameters of the learned model of each service business operator from the business operator server 210 through the input/output interface 511. Next, the secure computing unit 112 integrates the plurality of received concealed parameters by secure computation according to a predetermined combination rule, and outputs the parameters of the integrated model to the output unit 113 in a concealed format. The output unit 113 transmits the parameters of the integrated model to each business operator server 210 through the model input/output unit 213. When the business operator server 210 learns the model again and the parameter is updated after transmitting the parameter to the business operator server 210, the secure computing system 110 may receive the updated parameter again. The operations of the parameter acceptance unit 111, the secure computing unit 112, and the output unit 113 are similar to the operations of the parameter acceptance unit 101, the secure computing unit 102, and the output unit 103 in the first example embodiment, and thus the description thereof is omitted here.

### <Business Operator Server>

The business operator server 210 updates the model stored in the model storage unit 211 to a model to which the parameter received from the secure computing system 110 is applied. Specifically, the model input/output unit 213 receives the parameter in the concealed form and outputs the parameter to the restoration unit 214. Next, the restoration unit 214 restores the parameters and replaces them with the parameters of the model stored in the model storage unit 211. Next, the analysis unit 215 performs analysis using the updated model. The updated model is incorporated into a tool used by a service business operator to analyze a city optimization method. The analysis unit 215 analyzes the city task using the update model updated with the user's operation on the analysis tool as a trigger, and outputs the analysis result in a state where the analysis result can be viewed on a display device or the like. For example, in a tool for analyzing a city optimization method, when information regarding personal data of a plurality of individuals belonging to each city is input, the analysis unit 215 classifies the individuals based on the personal data and outputs a classification name. When classification information such as classification names classified based on personal data of a plurality of individuals belonging to a city is input, the analysis unit 215 outputs a proposed action to be proposed to an individual of the classification. In order to enhance the accuracy of the analysis result by the analysis unit 215, the business operator server 210 may perform learning again based on the additionally obtained personal data and further transmit the updated parameter to the secure computing system 110. In this manner, the update of the parameters by learning in each business operator server 210 and the integration of the parameters in the secure computing system 110 are repeated until, for example, predetermined conditions are satisfied, whereby the accuracy of the model can be further improved.

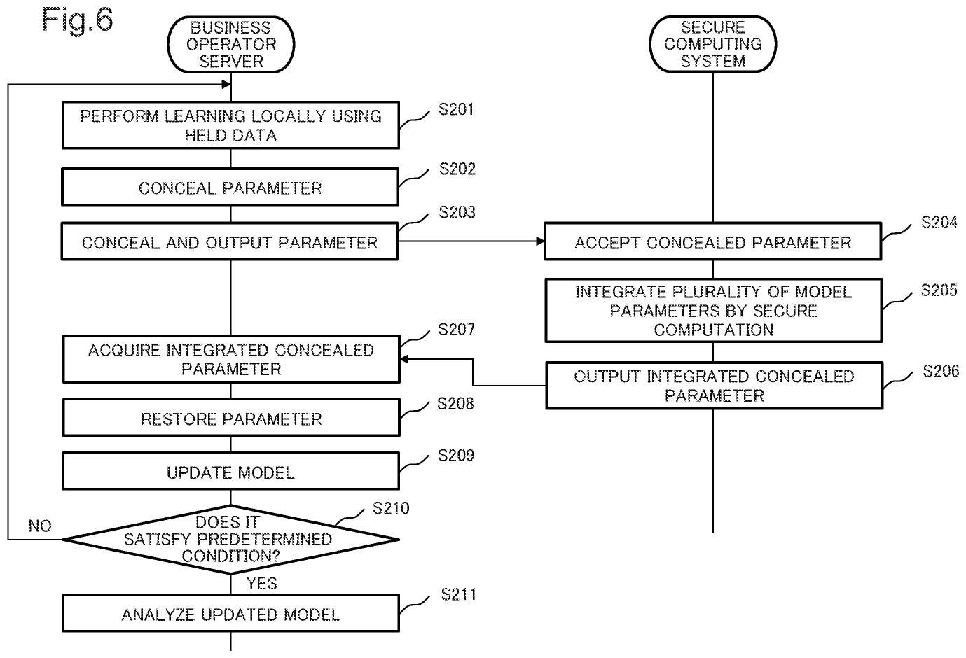

The operation of the information processing system 11 configured as described above will be described with reference to the flowchart of FIG. 6.

FIG. 6 is a flowchart illustrating an outline of an operation of the information processing system 11 according to the first example embodiment. The processing according to this flowchart may be executed based on program control by the processor described above.

As illustrated in FIG. 6, first, the business operator server 210 performs learning locally based on personal information of residents held by a service business operator (step S201). Next, the concealing unit 212 conceals the parameter of the model learned in each business operator server 210 (step S202). Next, the model input/output unit 213 outputs the parameter to the secure computing system 110 in a concealed form (step S203). Next, the parameter acceptance unit 111 of the secure computing system 110 receives the concealed parameter (step S204). Next, the secure computing unit 112 integrates the plurality of concealed parameters by secure computation (step S205). Next, the output unit 113 outputs the parameters integrated by the secure computing unit 112 to each of the business operator servers 210 in a concealed form (step S206). Next, the business operator server 210 acquires the integrated parameters in a concealed format through the model input/output unit 213 (step S207). Next, the restoration unit 214 restores the concealed parameters (step S208). Next, the business operator server 210 updates the model stored in the model storage unit 211 to a model to which the restored parameter is applied (step S209). Next, the business operator server 210 determines whether a predetermined condition is satisfied (step S210). In a case where the predetermined condition is satisfied (step S210: YES), the analysis unit 215 starts the analysis using the updated model, and ends the flow (step S211). In a case where the predetermined condition is not satisfied, the business operator server 210 returns to step S201 (step S210; NO) and performs the flow again. Thus, the information processing system 11 ends the operation of secure computation.

In the second example embodiment of the present disclosure, more accurate analysis results can be output by integrating parameters of a plurality of models for analyzing a city optimization method.

### Modification of Second Example Embodiment

A modification of the second example embodiment will be described. In a modification of the second example embodiment, a plurality of business operators of the second example embodiment are contractor candidates to which a city local government entrusts implementation of an optimization method. The modification of the second example embodiment further includes a contractor selection unit 119 that selects a contractor candidate. In a modification of the second example embodiment, for example, it is assumed that an activity of a local government is entrusted to a private company by a pay for success (PFS) or the like. That is, it is assumed that a private company performs an activity for achieving an achievement index which is a target of a city set by a local government. The contractor selection unit 119 performs matching between a business entrusted by the administrative agency and a company to be entrusted.

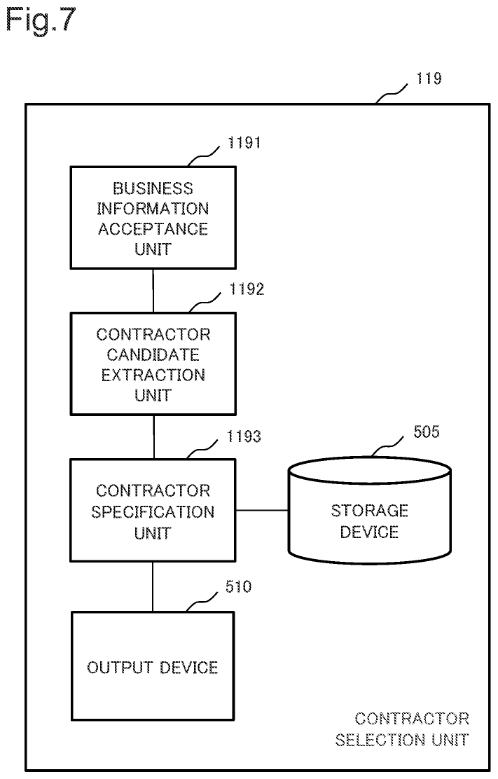

FIG. 7 is a block diagram illustrating a configuration of a contractor selection unit 119 according to a modification of the second example embodiment. As illustrated in FIG. 7, the contractor selection unit 119 includes a business information acceptance unit 1191 that receives an input of information regarding the entrusted business, a contractor candidate extraction unit 1192 that extracts a contractor candidate from past performance information of a business related to the entrusted business, and a contractor specification unit 1193 that specifies a contractor from the contractor candidates extracted by the contractor candidate extraction unit 1192.

The business information acceptance unit 1191 accepts input of information on the entrusted business through the input device 509. The information regarding the entrusted business is, for example, a success reward amount according to the entrusted business period, an achievement index, and an achievement level of the achievement index. The success reward amount may be set in stages depending on the achievement level of the achievement index. For example, the success reward amount may be higher as the achievement level is higher, such as 10 million yen for a medical cost reduction of 10% and 15 million yen for a medical cost reduction of 15%.

The contractor candidate extraction unit 1192 extracts information of company data (contractor candidate) having a past performance related to the achievement index received by the business information acceptance unit 1191 through the network. For example, the contractor candidate extraction unit 1192 may extract past performance information from administrative document management information registered in a blockchain among a plurality of administrative agencies.

The contractor specification unit 1193 specifies a contractor based on the past performance of the contractor candidate extracted by the contractor candidate extraction unit 1192 and evaluation information for the performance. The evaluation information includes, for example, an achievement level of an achievement index, presence or absence of issues at the time of past outsourcing, and the like. The contractor specification unit 1193 specifies a contractor from among the contractor candidates using a contractor analysis model generated based on the content of the past performance and the evaluation information for the performance. This model is, for example, a model that specifies and outputs an optimum entrusted business operator from among the contractor candidates when information of the contractor candidates extracted by the contractor candidate extraction unit 1192 is input. This model is, for example, a model generated by a decision tree, a neural network, a regression model, a deep learning neural network, or the like, and is stored in the storage device 505. In the present example embodiment, when information regarding the entrusted business is input, a model for outputting an optimum contractor may be used. In this case, a series of operations including acceptance of input of information regarding the entrusted business by the business information acceptance unit 1191, extraction of the contractor candidate by the contractor candidate extraction unit 1192, and specification of the contractor by the contractor specification unit 1193 are automatically executed. The contractor specification unit 1193 outputs the information regarding the specified contractor by, for example, the output device 510.

In the modification of the present example embodiment, after the entrusted business ends, the automatic computation of the success reward and the automatic payment of the success reward may be performed by the smart contract. The smart contract is a mechanism executed on a blockchain network and executed to perform a specific operation when a specific condition is satisfied as a trigger. In the payment of the success reward using the smart contract, the entrusted business operator inputs the result of the achievement index by the entrusted business on the blockchain, so that the success reward amount is automatically calculated, and the calculated success reward amount is paid to the entrusted business operator.

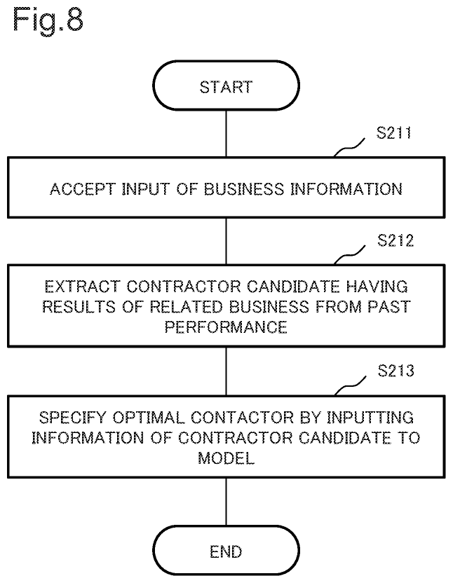

The operation of the contractor selection unit 119 configured as described above will be described with reference to the flowchart of FIG. 8. First, the business information acceptance unit 1191 receives an input of information regarding the entrusted business (step S211), and then the contractor candidate extraction unit 1192 extracts information of company data having past results related to the received achievement index as a contractor candidate (step S212). Finally, the contractor specification unit 1193 inputs the extracted information of the contractor candidate to the model and specifies a contractor (step S213). As described above, the contractor selection unit 119 ends the operation of the contractor selection.

In the modification of the present example embodiment, the contractor is specified using the model of the contractor analysis created based on the past performance content and the evaluation information for the performance. As a result, it is possible to select an optimal business contractor.

Although the present invention has been described with reference to each example embodiment, the present invention is not limited to the above example embodiments. Various modifications that can be understood by those of ordinary skill in the art can be made to the configuration and details of the present invention within the scope of the present invention.

For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

Some or all of the above example embodiments may be described as the following Supplementary Notes, but are not limited to the following.

### (Supplementary Note 1)

A secure computing system including:
a parameter acceptance means that is used for analysis of an optimization method of a city based on personal data of an individual belonging to the city, and accepts input of a plurality of concealed parameters of a plurality of models generated by each of a plurality of business operators;
a secure computing means that integrates the plurality of accepted concealed parameters by secret computation; and
an output means that outputs the parameters integrated by the secure computing means in a concealed form.

### (Supplementary Note 2)

The secure computing system according to Supplementary Note 1, in which the model is a model that, when information regarding the personal data of the individual belonging to each city is input, classifies the individual based on the personal data.

### (Supplementary Note 3)

The secure computing system according to Supplementary Note 1 or 2, in which the model is a model that, when classification information classified based on the personal data of the individual belonging to the city is input, outputs a proposed action proposed to the individual of the classification.

### (Supplementary Note 4)

The secure computing system according to any one of Supplementary Notes 1 to 3, in which the secure computation is a secure variation computation.

### (Supplementary Note 5)

The secure computing system according to any one of Supplementary Notes 1 to 4, in which the plurality of business operators in the secure computing means are contractor candidates to which implementation of the optimization method is entrusted by a local government of the city.

### (Supplementary Note 6)

The secure computing system according to Supplementary Note 5, further including:
a contractor selection means that selects the contractor candidate based on past performance information of a business related to the entrusted business.

### (Supplementary Note 7)

The secure computing system according to Supplementary Note 6, in which the contractor selection means includes: a business information acceptance means that accepts an input of information regarding an entrusted business; a contractor candidate extraction means that extracts a contractor candidate from past performance information of a business related to an entrusted business; and a contractor specification means that specifies a contractor from among contractor candidates extracted by the contractor candidate extraction means.

### (Supplementary Note 8)

The secure computing system according to Supplementary Note 7, in which the contractor candidate extraction means acquires past performance information based on administrative document management information.

### (Supplementary Note 9)

The secure computing system according to Supplementary Note 7 or 8, in which the contractor specification means specifies the contractor by using a model generated based on past performances and evaluation information for the performances.

### (Supplementary Note 10)

A business operator server including:
a model storage means that stores a model for analyzing an optimization method of a city based on personal data of an individual belonging to the city;
a concealing means that conceals parameters of a model stored in the model storage means;
a model input/output means that transmits parameters of the model to a secure computing system in a concealed form;
a restoration means that restores the concealed parameter: and
an analysis means that performs analysis regarding optimization of the city by using an updated model updated by federated learning using secure computation based on information held by each city, in which
the analysis means outputs a proposed action for solving a task in the city based on personal data of a resident belonging to the city.

### (Supplementary Note 11)

An information processing system including:
a plurality of business operator servers: and
a secure computing system, in which
the plurality of business operator servers each include:
a model storage means that stores a model generated based on personal data of an individual belonging to each city and performs analysis of an optimization method of the city;
a concealing means that conceals a parameter of a model stored in the model storage means;
a model input/output means that transmits a model to a secure computing system in a concealed form; and
a restoration means that restores the concealed parameter, and
the secure computing system includes:
a parameter acceptance means that is used for analysis of an optimization method of a city based on personal data of an individual belonging to the city, and accepts, for a plurality of models generated by each of a plurality of business operators, input of a plurality of concealed parameters of the plurality of models;
a secure computation means that integrates the plurality of concealed parameters by secure computation: and
an output means that outputs the parameters integrated by the secure computing means in a concealed form.

### (Supplementary Note 12)

A secure computing method including:
being used for analysis of an optimization method of a city based on personal data of an individual belonging to the city, and accepting input of a plurality of concealed parameters for a plurality of models generated by each of a plurality of business operators;
integrating the plurality of concealed parameters by secure computation; and
outputting the integrated parameters.

### (Supplementary Note 13)

A recording medium having stored therein a program for causing a computer to execute:
analyzing an optimization method of a city based on personal data of an individual belonging to the city, and accepting a plurality of concealed parameters of a plurality of models generated by each of a plurality of business operators;
integrating the plurality of concealed parameters by secure computation; and
outputting the integrated parameters.

### REFERENCE SIGNS LIST

10, 11 information processing system
100, 110 secure computing system
101, 111 parameter acceptance unit
102, 112 secure computing unit
103, 113 output unit
200, 210 business operator server
201, 211 model storage unit
202, 212 concealing unit
203, 213 model input/output unit
204, 214 restoration unit
215 analysis unit

What is claimed is:

1. A secure computing system comprising:
a memory storing instructions; and
at least one processor configured to execute the instructions to:
accept input of concealed parameters of a plurality of models generated by each of a plurality of business operators, wherein the plurality of models are used for analysis of an optimization method of a city based on personal data of an individual belonging to the city;
integrate the plurality of concealed parameters by secret computation; and
output the parameters integrated in a concealed form.

2. The secure computing system according to claim 1, wherein the at least one processor is further configured to execute the instructions to:
input information regarding the personal data of the individual belonging to each city to the model; and
classify the individual based on the personal data.

3. The secure computing system according to claim 1, wherein the at least one processor is further configured to execute the instructions to:
input classification information classified based on the personal data of the individual belonging to the city is input to the model; and
output a proposed action proposed to the individual of the classification.

4. The secure computing system according to claim 1, wherein the secure computation is a secure variation computation.

5. The secure computing system according to claim 1, wherein the plurality of business operators are contractor candidates to which implementation of the optimization method is entrusted by a local government of the city.

6. The secure computing system according to claim 5, wherein the at least one processor is further configured to execute the instructions to:
select the contractor candidate based on past performance information of a business related to the entrusted business.

7. The secure computing system according to claim 6, wherein the at least one processor is further configured to execute the instructions to:
accept an input of information regarding an entrusted business;
extract a contractor candidate from past performance information of a business related to an entrusted business; and
specify a contractor from among contractor candidates extracted.

8. The secure computing system according to claim 7, wherein the at least one processor is further configured to execute the instructions to:
acquire past performance information based on administrative document management information.

9. The secure computing system according to claim 7, wherein the at least one processor is further configured to execute the instructions to:
specify the contractor by using a model generated based on past performances and evaluation information for the performances.

10. A business operator server comprising:
a memory storing instructions; and
at least one processor configured to execute the instructions to:
store a model for analyzing an optimization method of a city based on personal data of an individual belonging to the city;
conceal parameters of a model stored;
transmit parameters of the model to a secure computing system in a concealed form;
restore the concealed parameter;
perform analysis regarding optimization of the city by using an updated model updated by federated learning using secure computation based on information held by each city; and
output a proposed action for solving a task in the city based on personal data of an individual belonging to the city.

11. An information processing system include:
a plurality of business operator servers; and
a secure computing system, wherein
the plurality of business operator servers each comprising:
a memory storing instructions; and
at least one processor configured to execute the instructions to:
store a model generated based on personal data of an individual belonging to each city and performs analysis of an optimization method of the city;
conceal a parameter of a model stored;
transmit a parameter of a model to a secure computing system in a concealed form; and
restore the concealed parameter, and
the secure computing system comprising:
a memory storing instructions; and
at least one processor configured to execute the instructions to:
accept, for a plurality of models generated by each of a plurality of business operators, input of a plurality of concealed parameters of the plurality of models, wherein the plurality of models are used for analysis of an optimization method of a city based on personal data of an individual belonging to the city;
integrate the plurality of concealed parameters by secure computation; and
output the parameters integrated in a concealed form.

12. A secure computing method comprising:
analyzing an optimization method of a city based on personal data of an individual belonging to the city, and accepting input of a plurality of concealed parameters for a plurality of models generated by each of a plurality of business operators;
integrating the plurality of concealed parameters by secure computation; and
outputting the integrated parameters in a concealed form.

13. A non-transitory recording medium having stored therein a program for causing a computer to execute:
analyzing an optimization method of a city based on personal data of an individual belonging to the city, and accepting input of a plurality of concealed parameters for a plurality of models generated by each of a plurality of business operators;
integrating the plurality of concealed parameters by secure computation; and
outputting the integrated parameters in a concealed form.
